(19) United States
(12) Patent Application Publication
(10) Pub. No.: US 2007/0031302 A1
(43) Pub. Date: Feb. 8, 2007

(54) Method and apparatus for purifying a gas

(76) Inventors: Carsten Wittrup, Basking Ridge, NJ (US); Ravi Jain, Bridgewater, NJ (US)

Correspondence Address: THE BOC GROUP, INC., 575 MOUNTAIN AVENUE, MURRAY HILL, NJ, 07974-2064, US

(21) Appl. No.: 11/500,130

(22) Filed: Aug. 7, 2006

Related U.S. Application Data
(60) Provisional application No. 60/706,329, filed on Aug. 8, 2005.

(51) Int. Cl. B01D 53/48; B01D 53/34; B32B 27/02

(52) U.S. Cl. 422/168; 423/224; 423/244.11

(57) ABSTRACT

The present invention provides for a method and apparatus for purifying carbon dioxide. Sulfur species and other impurities are removed from the carbon dioxide by a series of steps which include heater means, impurity adsorption means and catalysis means. Economical on-site analytical capabilities are also provided for by concentrating the impurities prior to their analysis.

### FIELD OF THE INVENTION

The present invention provides a method and apparatus for purifying and analyzing gases. In particular, this invention provides a method and apparatus for purifying and analyzing carbon dioxide for use as an additive and an ingredient in manufacturing operations requiring high purity carbon dioxide.

### BACKGROUND OF THE INVENTION

Carbon dioxide is used in a number of industrial and domestic applications, many of which require the carbon dioxide to be free from various impurities. Unfortunately carbon dioxide obtained from natural sources such as gas wells, chemical processes, fermentation processes or produced in industry, particularly carbon dioxide produced by the combustion of hydrocarbon products, often contains impurity levels of sulfur compounds such as carbonyl sulfide (COS) and hydrogen sulfide (H₂S) as well as oxygenates such as acetaldehydes and alcohols as well as aromatics such as benzene. When the carbon dioxide is intended for use in an application that requires the carbon dioxide to be of high purity, such as in the manufacture and cleaning of foodstuffs and beverage carbonation, medical products and electronic devices, the sulfur compounds and other hydrocarbon impurities contained in the gas stream must be removed to very low levels prior to use. The level of impurity removal required varies according to the application of carbon dioxide. For example, for beverage application the total sulfur level in carbon dioxide (CO₂) ideally should be below 0.1 ppm and aromatic hydrocarbons need to be below 0.02 ppm. For electronic cleaning applications removal of heavy hydrocarbons to below 0.1 ppm is required.

Various methods for removing sulfur compounds and hydrocarbon impurities from gases such as carbon dioxide are known. For example, U.S. Pat. No. 4,332,781, issued to Lieder et al., discloses the removal of COS and H₂S from a gas stream by first removing the H₂S from the hydrocarbon gas stream by contacting the gas stream with an aqueous solution of a regenerable oxidizing reactant, which may be a polyvalent metallic ion, such as iron, vanadium, copper, etc., to produce a COS-containing gas stream and an aqueous mixture containing sulfur and reduced reactant. The COS in the gas stream is subsequently hydrolyzed to CO₂ and H₂S by contacting the gas stream with water and a suitable hydrolysis catalyst, such as nickel, platinum, palladium, etc., after which the H₂S and, if desired, the CO₂ are removed. This step can be accomplished by the earlier described H₂S removal step or by absorption. The above-described process involves the use of cumbersome and costly equipment and liquid-based systems which require considerable attention and may result in the introduction of undesirable compounds, such as water vapor, into the carbon dioxide product.

U.S. Pat. Nos. 5,858,068 and 6,099,619 describe the use of a silver exchanged faujasite and an MFI-type molecular sieve for the removal of sulfur, oxygen and other impurities from carbon dioxide intended for food-related use. U.S. Pat. No. 5,674,463 describes the use of hydrolysis and reaction with metal oxides such as ferric oxide for the removal of carbonyl sulfide and hydrogen sulfide impurities from carbon dioxide.

It is known to directly remove sulfur compounds, such H₂S from a gas stream by contacting the gas stream with metal oxides, such as copper oxide, zinc oxide or mixtures of these. It is also known to remove sulfur impurities such as COS by first hydrolyzing COS to H₂S over a hydrolysis catalyst and then removing H₂S by reaction with metal oxides. Removal of H₂S by reaction with metal oxides can become expensive, since the catalyst is non-regenerable and expensive, when impurities such as COS and H₂S are present in more than trace amounts. Lower cost materials for the removal of COS and H₂S and other sulfur impurities such as mercaptans and dimethyl sulfide are desired to reduce CO₂ purification cost. Lower cost removal of other impurities such as acetaldehyde, alcohols and aromatics such as benzene is also required. Depending on the application (metals removal required for electronics and food, removal of pesticides required for food/beverage) the removal of other impurities such as metals and pesticides may also be required and methods to remove these impurities are desirable. Additionally analysis of various impurities such as sulfur compounds, aldehydes, alcohols and aromatics at low cost is desired.

Since many end users of carbon dioxide require the carbon dioxide they use to be substantially free of sulfur compounds, hydrocarbon and other impurities, and because natural sources of carbon dioxide and industrially manufactured carbon dioxide often contain sulfur and hydrocarbon compounds, economic and efficient methods for effecting substantially complete removal of sulfur and hydrocarbon compounds from carbon dioxide gas streams, without concomitantly introducing other impurities into the carbon dioxide, are continuously sought. Lower cost analysis methods for various impurities are also sought. It is desirable to have a simple and efficient method for achieving these objectives.

### SUMMARY OF THE INVENTION

The present invention provides for a method of purifying a gas comprising the steps of heating the gas and feeding the gas into a sulfur removal unit; further heating the carbon dioxide from sulfur removal unit and feeding the gas to a reactor bed to remove impurities by oxidation; cooling the gas stream exiting the reactor; removing the moisture and other impurities using a membrane and/or adsorption and reaction means; and feeding the purified gas to a process requiring purified gas.

In an embodiment, the gas for purification comprises carbon dioxide. In an embodiment, oxygen is added to the carbon dioxide before adding the gas into the sulfur removal unit. Depending on the impurity levels in the feed stream, all the steps in the process may not be required.

In another embodiment, the present invention provides for an apparatus for purifying a gas stream comprising: first heating or first heat exchange means; sulfur removal means; second heating or heat exchange means; reactor bed means; cooling/heat exchange means, membrane and/or adsorption and reaction means; and gas utilization means.

In another embodiment, the present invention provides for a method for the on-site treatment, including analysis and purification, of carbon dioxide comprising: a) feeding an impure carbon dioxide gas stream to a sulfur reactor bed to remove sulfur containing compounds present in the carbon dioxide gas stream to form a substantially sulfur-free carbon dioxide gas stream; b) feeding the substantially sulfur-free carbon dioxide gas stream to a reactor bed thereby removing hydrocarbon compounds present in the carbon dioxide gas stream to form a substantially hydrocarbon compound free carbon dioxide gas stream; c) feeding the substantially hydrocarbon compound free carbon dioxide stream to a dryer and/or an adsorption bed to form a substantially dry carbon dioxide stream; d) concentrating the impurities in the carbon dioxide stream and feeding the substantially dry carbon dioxide gas stream to an analytical skid to measure for the presence of any impurities in the substantially dry carbon dioxide gas; and e) feeding the purified carbon dioxide stream to either the manufacturer's operations or a carbon dioxide storage tank or to both simultaneously.

### BRIEF DESCRIPTION OF THE DRAWINGS

While the specification concludes with claims distinctly pointing the subject matter that Applicants regard as their invention, the invention would be better understood when taken in connection with the accompanying drawings in which:

FIG. 1 is a schematic description of the overall process for purifying and analyzing the carbon dioxide that will be used in a manufacturing, cleaning, packaging, filling or production process; and

FIG. 2 is a schematic description of purifying carbon dioxide in a carbon dioxide production plant.

### DETAILED DESCRIPTION OF THE INVENTION

The carbon dioxide that is typically produced for industrial operations has a number of impurities present in it. These impurities will often be a concern for many uses of the carbon dioxide, but in the production of products intended for human consumption such as carbonated beverages, and electronic manufacturing the purity of the carbon dioxide is paramount and can influence the taste, quality, and legal compliance of the finished product.

The impure carbon dioxide which can be obtained from any available source of carbon dioxide will typically contain as impurities sulfur compounds such as carbonyl sulfide, hydrogen sulfide, dimethyl sulfide, sulfur dioxide and mercaptans, hydrocarbon impurities such as aldehydes, alcohols, aromatics, propane, ethylene, and other impurities such as water, carbon monoxide, metals and pesticides. This invention describes novel methods for the removal of various impurities and novel methods for the analysis of some of the impurities. The impurity removal and analysis methods can be used in various ways depending on whether the carbon dioxide is purified at a production plant, or at the point of use. Various point of use applications of carbon dioxide include a beverage filling plant, a food freezing plant, an electronics manufacturing plant and a fountain type carbon dioxide dispensing location.

For the purposes of this invention at least some of the sulfur impurities such as hydrogen sulfide and carbonyl sulfide are removed at an elevated temperature, a temperature of 50° to 150° C. In a production plant this temperature may be obtained during the compression of feed carbon dioxide after the final compression stage but before the aftercooler. In a point of use application this temperature can be obtained by using a combination of heater and heat exchange means. The impure carbon dioxide gas stream having been raised to the proper temperature is directed to a sulfur reactor bed. This bed is typically a vessel that will contain certain catalyst and adsorbent materials which will either react with or adsorb the sulfur compounds.

Preferably, the catalyst materials are those that will cause the H₂S and COS to convert to elemental sulfur which is retained on the purification media or react with the sulfur impurities to form metal oxides. The sulfur impurities such as mercaptans can simply be adsorbed on the purification media. Some of the materials may require oxygen to convert sulfur compounds such as hydrogen sulfide to sulfur and both oxygen and water to convert carbonyl sulfide to hydrogen sulfide and then to sulfur. The sulfur purification materials according to this invention include carbonates and hydroxides such as sodium and potassium hydroxides or carbonates on activated carbon; metal oxides such as copper, zinc, chromium or iron oxide either alone or supported on a microporous adsorbent such as activated alumina, activated carbon or silica gel. Other materials such as a CuY zeolite are effective for the removal of carbonyl sulfide and sulfur dioxide impurities through reaction. Use of elevated temperatures for sulfur removal significantly improves removal capacity for both hydrogen sulfide and carbonyl sulfide compared to operation near ambient temperatures.

For the purposes of this invention, the hydrocarbon impurities are removed either by a combination of catalytic oxidation and adsorption or by adsorption alone. The adsorption bed can remove any unconverted impurities from the catalyst bed as well as water or most of the impurities when the catalyst bed is not used. In a production plant the catalytic reactor will be either after the sulfur removal bed, after the feed compression step, or after the water wash step. In a point of use application the catalyst bed will be after the sulfur removal bed. The stream temperature need to be raised to between 150° and 450° C. for the oxidation of various hydrocarbon impurities. The reactor temperature depends on the impurity to be removed as well as the catalyst used.

The carbon dioxide gas stream which is sufficiently free of sulfur compound impurities is directed to the above mentioned catalytic reactor after passing through a heater and/or heat exchanger means to raise the temperature of the stream. The catalytic reactor can contain a monolith catalyst or a catalyst in pelleted form. The materials used in the catalytic reactor are typically noble metals such as platinum or palladium on a particulate or monolith support. The reactor bed purifies the carbon dioxide by oxidation reactions and oxygen is added prior to the catalyst bed or prior to the sulfur removal bed in appropriate amount. The impurities such as propane, aldehydes, alcohols, acetates and aromatics are converted to carbon dioxide and water in the catalyst bed. Any sulfur impurities remaining after the sulfur removal step may be converted to sulfur dioxide in the catalyst beds. The temperature of the catalyst bed depends on the impurities in the feed. For impurities such as alcohols, aldehydes and aromatics temperatures in the range of 150° to 300° C. are needed. However, for other impurities such as methane, ethane and propane temperatures higher than 300° C. and sometimes higher than 450° C. are required. The catalytic reactor will also remove impurities such as carbon monoxide by oxidation to carbon dioxide. Oxygen in excess of stoichiometric amount needed for the oxidation reactions is required for proper removal of impurities and proper control of amount of oxygen added is needed.

The stream exiting the reactor beds or the sulfur removal beds or the compressor is cooled to close to ambient temperature in heat exchange means and sent to the adsorbent bed(s) for the removal of water and other residual impurities. The adsorbents used will depend on the impurities in the feed. Typically, an adsorbent such as activated alumina (AA), or a zeolite such as 4A or 13X or silica gel will be used for moisture removal. Additionally, for the purposes of this invention the adsorbent bed(s) will contain a zeolite such as NaY or its ion-exchanged forms, for the removal of impurities such as aldehydes, alcohols such as methanol and ethanol, acetates such as methyl and ethyl acetates and some of the trace sulfur compounds such as dimethyl sulfur compounds. For these impurities Y zeolites have significantly higher capacity than other zeolites and non-zeolitic materials. For aromatics such as benzene and toluene other adsorbents such as activated carbon or dealuminated Y zeolite (DAY) can be used.

For multiple impurities the adsorbents in the bed need to be layered. A typical bed arrangement for feed from the bottom will be a water removal adsorbent in the bottom followed by a Y zeolite in the middle and an activated carbon/DAY adsorbent in the top. The adsorbent can be used in once through mode where the adsorbent material is replaced after it has been used up or they can be regenerated. A thermal regeneration with a stream relatively free of impurities will typically be carried out. For continuous operation two or more beds are needed so that while one or more beds are being regenerated one or more beds are in purification mode.

For the purposes of this invention various impurities at various stages of the process are analyzed by a sulfur analyzer and a hydrocarbon analyzer. These two analyzers could be in a single unit such as a gas chromatograph or they could be separate units. Prior to analysis, various sulfur and hydrocarbon impurities can be concentrated to increase their amounts in the sample. This step improves the detection limits for various analyzers. This is particularly useful for impurities such as benzene which are required to be removed to below 20 ppb for beverage applications.

The sulfur analyzer unit will analyze either the total sulfur or individual sulfur species in the feed, various process stages and in the final product. For beverage grade carbon dioxide the total sulfur in the product excluding sulfur dioxide needs to be below 0.1 ppm and sulfur dioxide needs to be below 1 ppm.

The hydrocarbon analyzer will analyze both the total hydrocarbons (as methane) or individual hydrocarbon species in the feed, various process stages and in the final product. For beverage grade carbon dioxide the total hydrocarbons in the product need to be below 50 ppm with different limit for individual components such as benzene (<20 ppb), acetaldehyde (<0.1 ppm) and methanol (<10 ppm).

Various combinations of purification and analytical techniques described can be used to address various CO₂ purification needs. For point of use purification such as purification of carbon dioxide prior to beverage fill or electronic manufacturing the impure carbon dioxide will be transported from a storage tank into the purification equipment at flow typical of customer usage. These flow rates can range from 100 to 10,000 sm³/hr (standard cubic meters per hour) depending on the final application and the size of the production facility. The carbon dioxide will typically be at a pressure in the range of about 1.5 to about 21 bara with about 15 to about 19.5 bara being typical. In certain applications, particularly those related to the carbon dioxide for electronic cleaning, the pressures could range between 60 to several hundred bara.

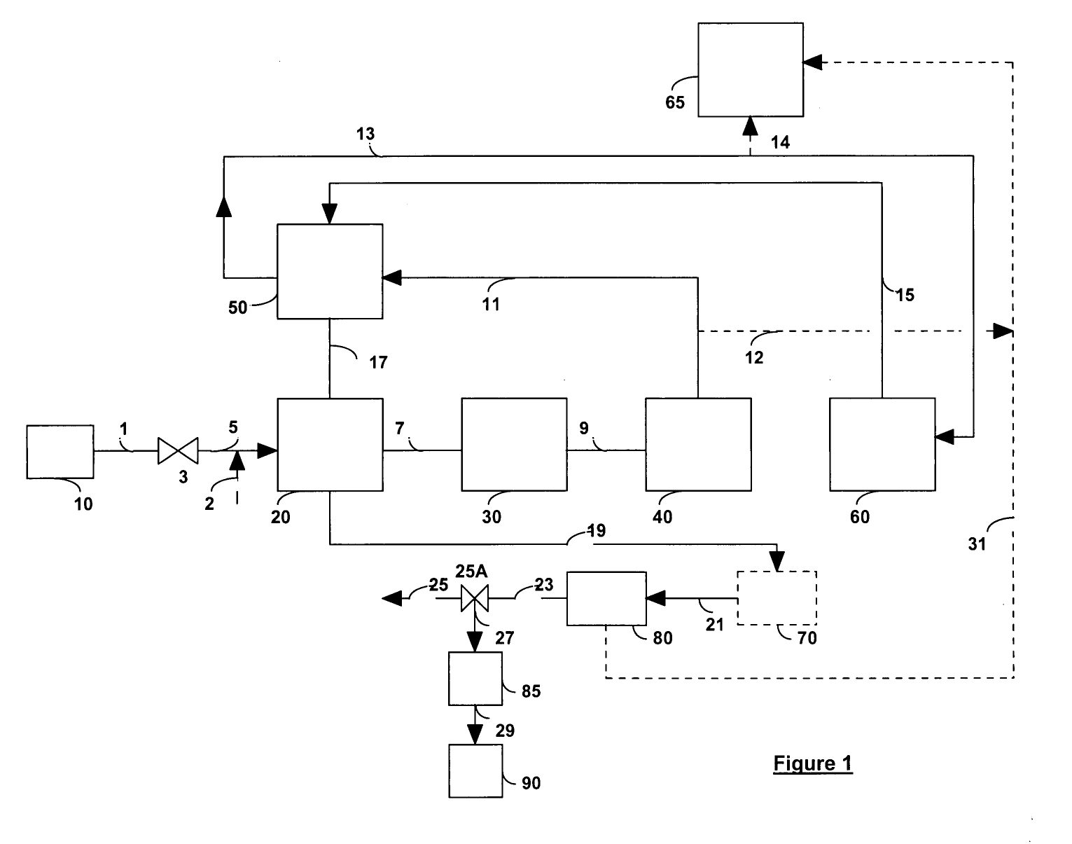

Turning to the figures, FIG. 1 is an overview of the carbon dioxide purification process at the point of use. Depending on impurities in the feed some components of this process can be eliminated. Carbon dioxide containing impurities is directed from tank 10 along line 1 through pressure regulator 3 and line 5 to a first heat exchanger 20. Oxygen is added to this stream via line 2 for use in the sulfur removal bed and in the catalytic reactor. An optional flow controller, not shown, can be employed to measure and control the impure carbon dioxide flow from tank 10. The first heat exchanger 20 will raise the temperature of the impure carbon dioxide from about ambient to about 40-120° C. The heated impure carbon dioxide leaves the first heat exchanger through line 7 to a heater 30 where its temperature is maintained at around 50-150° C. For certain situations the heat exchanger 20 may be eliminated and only heater 30 may be used to increase the temperature of the stream. The impure carbon dioxide will leave the heater through line 9 and enter the sulfur removal bed 40. The sulfur removal bed contains various materials such as supported carbonates, hydroxides and oxides for the removal of various sulfur impurities such as hydrogen sulfide, COS and mercaptans. A sample can be taken through line 12 and sent to the analyzer skid 65 to provide real time readings of sulfur impurity concentration levels in the sulfur reactor bed.

The impure carbon dioxide which is now essentially free of most sulfur impurities is directed through line 11 to a second heat exchanger 50 where its temperature is raised to over 150° C. The impure carbon dioxide exits the second heat exchanger through line 13 and is further heated to a temperature between 150 and 450° C. in a heater not shown. The heated carbon dioxide enters a catalyst reactor 60 containing a pelleted or a monolith catalyst. Various impurities such as benzene and aldehydes in the feed react with oxygen in the catalytic reactor and are converted to carbon dioxide and water. Some of the remaining sulfur impurities in the feed may be converted to sulfur dioxide in this reactor.

The now essentially purified carbon dioxide gas stream leaves the catalytic reactor bed through line 15 where it returns to the second heat exchanger 50. Line 14 directs some of this purified carbon dioxide gas to an analytical skid 65 where the carbon dioxide gas stream is analyzed for purity.

The purified carbon dioxide gas stream leaves the second heat exchanger through line 17 and is directed into the first heat exchanger 20 where its temperature is reduced to less than 40° C. The cooled purified carbon dioxide gas steam leaves the first heat exchanger through line 19 to an optional membrane dryer 70 where most of the water present in the carbon dioxide gas stream is removed. The purified carbon dioxide leaves the optional membrane dryer through line 21 and enters an adsorbent bed 80 which will serve as a backup to the catalytic reactor bed 60 and the sulfur removal bed 40 and assist in removing any impurities that may still be present in the carbon dioxide gas stream. If a membrane dryer is used for water removal the adsorbent 80 will typically contain two adsorbent layers, a zeolite such as a Y zeolite layer for the removal of aldehydes, alcohols, acetates and DMS, and an activated carbon layer for the removal of aromatic impurities such as benzene and toluene. The activated carbon layer may be impregnated with carbonates, hydroxides or metal oxides for the removal of residual sulfurs such as hydrogen sulfide and carbonyl sulfide. If the membrane dryer is not used an additional adsorbent layer consisting of activated alumina or silica gel or zeolites such as 3A, 4A, 13X and NaY is needed for the removal of moisture. This adsorbent bed may be thermally regenerated with a stream essentially free of impurities at temperatures between 150 and 300° C. Part of purified carbon dioxide may be used as the regeneration gas.

A small sample of purified carbon dioxide exiting bed 80 is returned to the analytical skid 65 through line 24 to check for any impurities that may still be present in the carbon dioxide gas stream. The majority of the carbon dioxide exits the adsorbent bed through line 23 to valve 25A. This valve splits the carbon dioxide gas stream such that about 90% goes directly to the manufacturing operation through line 25 and about 10% is directed through line 27 through a chiller 85 to liquefy carbon dioxide and line 29 to a backup pure carbon dioxide tank 90.

Analytical skid contains a sample concentrator and one or more detectors for the analysis of various impurities such as sulfur compounds, hydrocarbons, aromatics and oxygenates. The sample concentrator is typically based on adsorption of impurities for a length of time and then desorbing them into the detector. A FID (flame ionization detector) or a PID (photoionization detector) can be used for hydrocarbons, aromatics and oxygenates. A FPD (flame photometric detector) or a SCD (sulfur chemiluminescence detector) can be used for the measurement of sulfur impurities.

The apparatus and processes of the present invention are designed to address concerns with carbon dioxide impurities, particularly with carbon dioxide supplied at the point of use in the manufacturers' process. By purifying and analyzing at the same time, the operator of the production facility can rely on a steady supply of purified and quality assured carbon dioxide while the invention can also supply a back up tank with purified carbon dioxide to be used in any given situation where the real time supply of purified carbon dioxide is not sufficient or available to satisfy the demand. This allows the operator greater operating control over the purification process because the operator can stop or pause the process of purification if the impurity levels are not satisfactory for various impurities in the carbon dioxide.

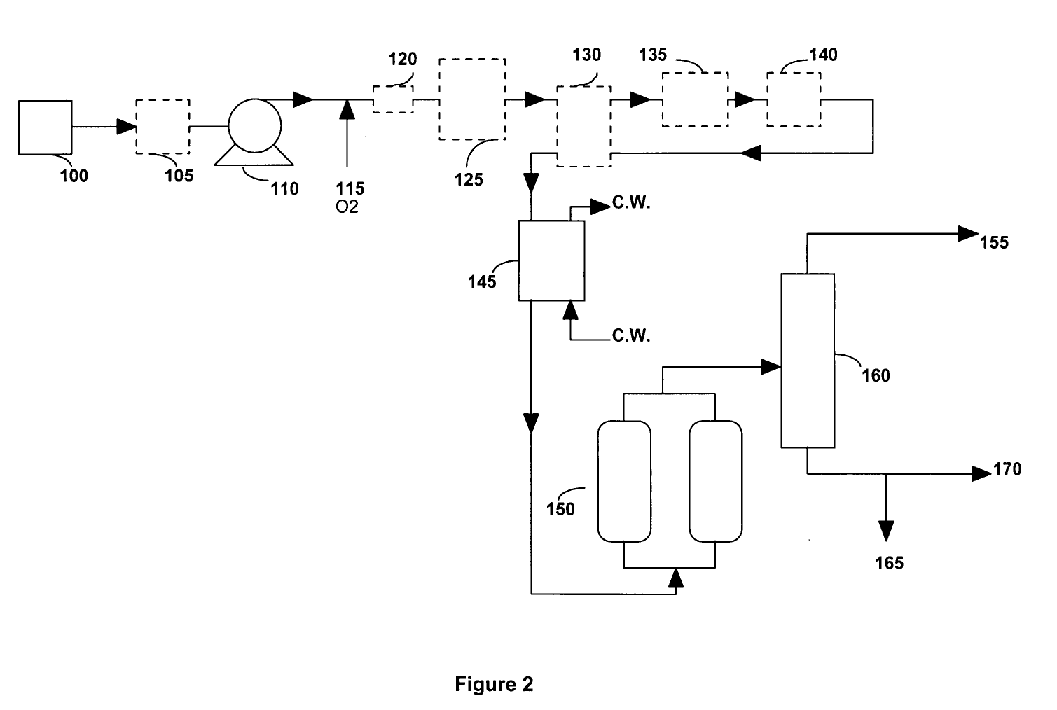

Purification of carbon dioxide in a carbon dioxide production plant using various aspects of this invention is shown in FIG. 2. Carbon dioxide from source 100 is sent to an optional metals/pesticides removal unit 105. As discussed earlier this unit may consist of one or more purification processes chosen from adsorption, water wash column, electrostatic precipitator or a filtration unit. The carbon dioxide exiting unit 105 is sent to a compressor 110 to raise its pressure to between 14 and 20 barg and oxygen is added to the compressed stream at line 115. The stream exiting the final compression stage will be at a temperature between 70° and 95° C. and is sent to an optional heater unit 120 to further increase its temperature to between 75 and 150° C. and is then sent to the optional sulfur removal unit 125 where sulfur impurities such as hydrogen sulfide, carbonyl sulfide, and mercaptans are removed by reaction with metal oxides, hydroxides or carbonates, or copper exchanged zeolites. Some of the reaction products such as sulfur may also be adsorbed on supports such as activated carbons and activated alumina.

The stream exiting the optional sulfur removal unit 125 is further heated in an optional heat exchanger 130 and optional heater 135 and enters the optional catalytic reactor 140. The catalytic reactor contains supported noble metal catalysts such as palladium or platinum in pelleted or monolith forms. The catalytic reactor operates at a temperature between 150 and 450° C. depending on the impurities in the feed stream. The hydrocarbon impurities are oxidized to water and carbon dioxide in this reactor. The stream exiting reactor 140 is cooled in heat exchanger 130 and further cooled in a water cooled aftercooler 145 to a temperature close to ambient.

The stream exiting aftercooler 145 is sent to an adsorption system 150 for the removal of moisture and other impurities. The size of the adsorption beds depends on the impurities in feed stream 100 and whether or not reactor 140 is used. The adsorption beds in adsorption system 150 will have an adsorbent for moisture removal, an adsorbent for the removal of oxygenates such as aldehydes, alcohols and acetates, an adsorbent for the remaining sulfur impurities such as DMS, and an adsorbent for remaining aromatics' such as toluene and benzene. A typical bed configuration would include activated alumina, silica gel, zeolite 13X or 4A for moisture removal, a NaY zeolite or its ion-exchanged forms for the removal of oxygenates and DMS, and an activated carbon or DAY zeolite for the removal of aromatics and other impurities. Two or more beds would normally be used for continuous operation wherein one bed purifies the carbon dioxide stream and the other is being regenerated with a stream free of impurities. Purified carbon dioxide exiting adsorption system 150 is liquefied and optionally distilled in unit 160 and sent to product storage via line 170. The feed and purified carbon dioxide streams are analyzed using the analytical system described earlier. Purified carbon dioxide not meeting purity requirements can be vented via line 165 and is not sent to storage. Any non-condensibles in the product are removed via line 155.

The industries or customers where the present invention will have utility include but are not limited to the manufacturing and cleaning of foodstuffs; the manufacture of electronics, electronic components and subassemblies; the cleaning of medical products; carbonation of soft drinks, beer and water; blanketing of storage tanks and vessels that contain flammable liquids or powders; blanketing of materials that would degrade in air, such as vegetable oil, spices, and fragrances.

The invention is further illustrated through examples.

### EXAMPLE 1

Testing was performed using a purification skid similar to that described in FIG. 1 to purify carbon dioxide. The carbon dioxide feed conditions were as follows:

| | |
|---|---|
| Pressure | 17 bara |
| Temperature | 25° C. |
| Flow Rate | 109.7 std m³/hr |
| H₂S | 5 to 9 ppm |
| COS | 5 ppm |
| Benzene | 2.5 ppm |
| Methanol | 160 ppm |
| Acetaldehyde | 11 ppm |
| Oxygen | About 50 ppm over the amount needed for H₂S, COS, |
| | benzene, acetaldehyde and methanol removal. |

The sulfur reactor bed was operated at a temperature of 100° C. and contained 17.1 kgs of activated carbon impregnated with 20 wt % potassium carbonate. The catalytic reactor bed was operated at 250° C. and contained a palladium coated catalyst.

The unit was operated for over a week and the product was analyzed using a gas chromatograph containing an FID and FPD detectors and a sample concentrator. During the testing period the total sulfur in product exiting the sulfur removal bed 40 remained below 0.05 ppm and benzene, methanol and acetaldehyde were all below the detection limit of the instrument, less than 10 ppb each. An adsorption based sample concentrator allowed the increase in the concentration of hydrocarbon impurities by a factor of over 100 significantly increasing the detection limits for these impurities.

### EXAMPLE 2

To check the operation of unit 80 in FIG. 1, a feed containing 145 ppm methanol in carbon dioxide at a pressure of 14.6 bara and a temperature of 25° C. was passed through a bed containing 0.295 kgs of 6×8 mesh NaY zeolite at a flow rate of 19.8 std liters/min. No methanol breakthrough (<1 ppm methanol in product) was seen for 170 hours and an equilibrium methanol capacity of 16.4 wt % was obtained.

While the present invention has been described with reference to several embodiments and examples, numerous changes, additions and omissions, as will occur to those skilled in the art, may be made without departing from the spirit and scope of the present invention.

What is claimed is:

1. An apparatus for purifying a gas stream comprising:
a first heater/heat exchange means;
a sulfur removal means;
a second heater/heat exchange means;
a reactor bed means;
a cooling/heat exchange means;
an adsorption purification means; and
a gas recovery means.

2. The apparatus as claimed in claim 1 wherein the gas stream comprises carbon dioxide.

3. The apparatus as claimed in claim 1 wherein the sulfur removal means comprise a sulfur reactor bed.

4. The apparatus as claimed in claim 3 wherein the sulfur bed contains a catalyst that reacts with H₂S and COS.

5. The apparatus as claimed in claim 4 wherein the catalyst is selected from the group consisting of carbonates and hydroxides, carbonates on activated carbon, carbonates on activated alumina, metal oxides, metal oxides supported on a microporous adsorbents, and CuY zeolite.

6. The apparatus as claimed in claim 1 wherein the reactor bed is a particulate or a monolith reactor bed.

7. The apparatus as claimed in claim 1 wherein the monolith reactor bed contains one or more catalyst materials.

8. The apparatus as claimed in claim 1 wherein the adsorption purification means are one or more adsorbent materials.

9. The apparatus as claimed in claim 8 wherein the activated alumina and 13X are layered on top of each other.

10. The apparatus as claimed in claim 9 further comprising a NaY zeolite adsorbent.

11. The apparatus as claimed in claim 8 wherein the adsorbent materials are in the shape of beads, pellets, powder, mesh, rings, monoliths or extrudates.

12. The apparatus as claimed in claim 1 wherein the adsorption purification means comprises activated carbon.

13. The apparatus as claimed in claim 1 wherein said the gas removal means comprises valve means for directing the gas to either a manufacturing, cleaning, packaging, storage or filling process or device.

14. The apparatus as claimed in claim 1 further comprising gas analytical means for sulfur and hydrocarbon impurities.

15. The apparatus as claimed in claim 1 further comprising the removal of bacteria, pesticides and heavy metals from the gas.

16. A method of purifying a gas comprising the steps:
a) feeding the gas to a first heater/heat exchanger to increase the temperature of the gas;
b) feeding the gas from step a) into a sulfur removal unit to form a substantially sulfur free gas;
c) feeding the substantially sulfur free gas to a second heater/heat exchanger thereby increasing the temperature of the gas;
d) feeding the gas to a reactor bed to remove impurities;
e) feeding the gas to cooler/heat exchange means to reduce the gas temperature;
f) feeding said gas to adsorption purification means; and
g) feeding the gas to a manufacturing, cleaning, filling, storage, mixing, or packaging process or device.

17. The method as claimed in claim 16 wherein the gas comprises carbon dioxide gas.

18. The method as claimed in claim 16 wherein the sulfur removal means comprise a sulfur reactor bed.

19. The method as claimed in claim 18 wherein the sulfur bed contains a catalyst that reacts with H₂S and COS.

20. The method as claimed in claim 19 wherein the catalyst is selected from the group consisting of carbonates and hydroxides, carbonates on activated carbon, carbonates on activated alumina, metal oxides, metal oxides supported on a microporous adsorbent, and CuY zeolite.

21. The method as claimed in claim 16 wherein the reactor bed is a particulate or a monolith reactor bed.

22. The method as claimed in claim 16 wherein the monolith reactor bed contains one or more catalyst materials.

23. The method as claimed in claim 16 wherein the adsorption purification means are activated alumina and 13X zeolite.

24. The method as claimed in claim 23 further comprising a NaY zeolite adsorbent.

25. The method as claimed in claim 23 wherein the adsorbent materials are in the shape of beads.

26. The method as claimed in claim 24 wherein the adsorption purification means further comprises activated carbon.

27. The method as claimed in claim 16 wherein said the gas removal means comprises valve means for directing said the gas to either a production process or storage or both simultaneously.

28. The method as claimed in claim 16 further comprising gas analytical means.

29. The method as claimed in claim 16 further comprising removing bacteria, pesticides and heavy metals from the carbon dioxide.

30. A method for the treatment of carbon dioxide comprising:
a) feeding an impure carbon dioxide gas stream to a sulfur reactor bed to remove sulfur containing compounds present in the carbon dioxide gas stream to form a substantially sulfur-free carbon dioxide gas stream;
b) feeding the substantially sulfur-free carbon dioxide gas stream to a reactor bed thereby removing hydrocarbon compounds present in the carbon dioxide gas stream to form a substantially hydrocarbon compound free carbon dioxide gas stream;
c) feeding the substantially hydrocarbon compound free carbon dioxide stream to a dryer and/or an adsorption bed to form a substantially dry carbon dioxide stream;
d) concentrating the impurities in the carbon dioxide stream and feeding the substantially dry carbon dioxide gas stream to an analytical skid to measure for the presence of any impurities in the substantially dry carbon dioxide gas stream; and
e) feeding the purified carbon dioxide stream to either the manufacturer's operations or a carbon dioxide storage tank or to both simultaneously.

31. The method as claimed in claim 30 wherein the treatment comprises purifying the carbon dioxide.

32. The method as claimed in claim 30 wherein the treatment comprises analyzing the carbon dioxide.

33. The method as claimed in claim 30 wherein the treatment is conducted on site.

34. The method as claimed in claim 30 wherein the sulfur removal means comprise a sulfur reactor bed.

35. The method as claimed in claim 34 wherein the sulfur bed contains a catalyst that reacts with H₂S and COS.

36. The method as claimed in claim 35 wherein the catalyst is selected from the group consisting of carbonates and hydroxides, carbonates on activated carbon, carbonates on activated alumina, metal oxides, metal oxides supported on a microporous adsorbent, and CuY zeolite.

37. The method as claimed in claim 30 wherein the carbon dioxide removal means comprises valve means for directing the carbon dioxide to either a production process or storage or both simultaneously.
